(19) United States
(12) Patent Application Publication
(10) Pub. No.: US 2024/0129729 A1
(43) Pub. Date: Apr. 18, 2024

(54) REROUTING MESSAGE TRANSMISSIONS

(71) Applicant: Lenovo (Singapore) Pte. Ltd., New Tech Park (SG)

(72) Inventors: Sheeba Backia Mary Baskaran, Friedrichsdorf (DE); Ravi Kuchibhotla, Chicago, IL (US); Andreas Kunz, Ladenburg (DE); Genadi Velev, Darmstadt (DE)

(21) Appl. No.: 18/546,241

(22) PCT Filed: Feb. 9, 2022
(86) PCT No.: PCT/IB2022/051137

§ 371 Date: Aug. 11, 2023

Related U.S. Application Data
(60) Provisional application No. 63/148,521, filed on Feb. 11, 2021.

(51) Int. Cl. H04W 12/06; H04W 12/08

(52) U.S. Cl. CPC H04W 12/06; H04W 12/08; H04W 48/18

(57) ABSTRACT

Apparatuses, methods, and systems are disclosed for rerouting message transmissions. One method includes receiving, at a first network device, a registration request message. The method includes delaying, by the first network device, primary authentication, security setup, or a combination thereof based at least partly on a subscription permanent identifier (SUFI) from a second network device and subscription information. The method includes determining, at the first network device, whether to transmit a reroute non-access stratum (NAS) message.

### CROSS-REFERENCE TO RELATED APPLICATIONS

This application claims priority to U.S. Patent Application Ser. No. 63/148,521 entitled “APPARATUSES, METHODS, AND SYSTEMS FOR ENABLING A UE TO ESTABLISH SECURITY SETUP WITH A REALLOCATED AMF CAPABLE OF SERVING THE UE” and filed on Feb. 11, 2021 for Sheeba Backia Mary Baskaran, which is incorporated herein by reference in its entirety.

### FIELD

The subject matter disclosed herein relates generally to wireless communications and more particularly relates to rerouting message transmissions.

### BACKGROUND

In certain wireless communications networks, security procedures may establish security between a user equipment (“UE”) and an access and mobility management function (“AMF”). In such networks, the AMF may not be able to serve the UE.

### BRIEF SUMMARY

Methods for rerouting message transmissions are disclosed. Apparatuses and systems also perform the functions of the methods. One embodiment of a method includes receiving, at a first network device, a registration request message. In some embodiments, the method includes delaying, by the first network device, primary authentication, security setup, or a combination thereof based at least partly on a subscription permanent identifier (SUPI) from a second network device and subscription information. In certain embodiments, the method includes determining, at the first network device, whether to transmit a reroute non-access stratum (NAS) message.

One apparatus for rerouting message transmissions includes a first network device. In some embodiments, the apparatus includes a receiver that receives a registration request message. In various embodiments, the apparatus includes a processor that: delays primary authentication, security setup, or a combination thereof based at least partly on a subscription permanent identifier (SUPI) from a second network device and subscription information; and determines whether to transmit a reroute non-access stratum (NAS) message.

Another embodiment of a method for rerouting message transmissions includes receiving, at a third network device, a request message. In some embodiments, the method includes determining, by the third network device, whether to obtain security context information from a fourth network device. In certain embodiments, the method includes, in response to determining to obtain the security context information, transmitting a request for the security context information to the fourth network device.

Another apparatus for rerouting message transmissions includes a third network device. In some embodiments, the apparatus includes a receiver that receives a request message. In various embodiments, the apparatus includes a processor that determines whether to obtain security context information from a fourth network device. In certain embodiments, the apparatus includes a transmitter that, in response to determining to obtain the security context information, transmits a request for the security context information to the fourth network device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for rerouting message transmissions;

FIG. 2 is a schematic block diagram illustrating one embodiment of an apparatus that may be used for rerouting message transmissions;

FIG. 3 is a schematic block diagram illustrating one embodiment of an apparatus that may be used for rerouting message transmissions;

FIG. 4 is a schematic block diagram illustrating one embodiment of a system for determining, at an initial AMF, to not use a UE context fetched from an old AMF and/or to skip NAS SMC;

FIG. 5 is a schematic block diagram illustrating another embodiment of a system for determining, at an initial AMF, to not use a UE context fetched from an old AMF and/or to skip NAS SMC;

FIG. 6 is a schematic block diagram illustrating one embodiment of a system for determining, at a target AMF, to fetch an available UE security context from an old AMF or from an AUSF;

FIG. 7 is a flow chart diagram illustrating one embodiment of a method for rerouting message transmissions; and

FIG. 8 is a flow chart diagram illustrating another embodiment of a method for rerouting message transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

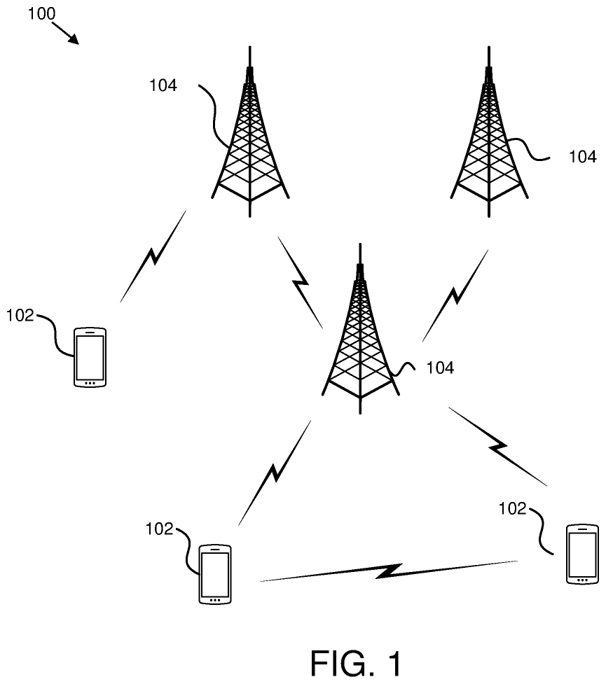

FIG. 1 depicts an embodiment of a wireless communication system 100 for rerouting message transmissions. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a first network device, a registration request message. In some embodiments, the network unit 104 may delay, by the first network device, primary authentication, security setup, or a combination thereof based at least partly on a subscription permanent identifier (SUPI) from a second network device and subscription information. In certain embodiments, the network unit 104 may determine, at the first network device, whether to transmit a reroute non-access stratum (NAS) message. Accordingly, the network unit 104 may be used for rerouting message transmissions.

In certain embodiments, a network unit 104 may receive, at a third network device, a request message. In some embodiments, the network unit 104 may determine, by the third network device, whether to obtain security context information from a fourth network device. In certain embodiments, the network unit 104 may, in response to determining to obtain the security context information, transmit a request for the security context information to the fourth network device. Accordingly, the network unit 104 may be used for rerouting message transmissions.

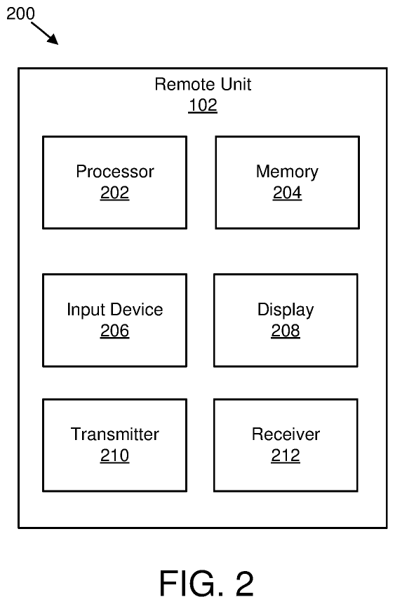

FIG. 2 depicts one embodiment of an apparatus 200 that may be used for rerouting message transmissions. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

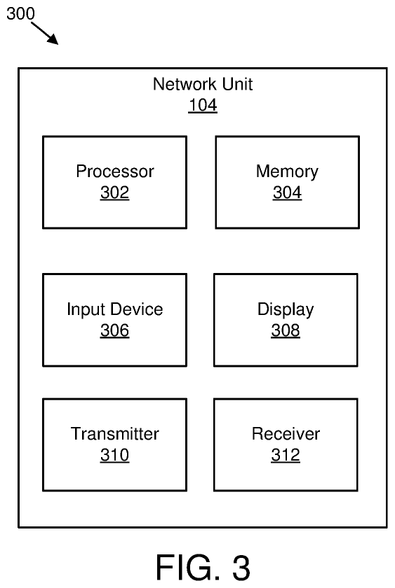

FIG. 3 depicts one embodiment of an apparatus 300 that may be used for rerouting message transmissions. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives a registration request message. In various embodiments, the processor 302: delays primary authentication, security setup, or a combination thereof based at least partly on a subscription permanent identifier (SUPI) from a second network device and subscription information; and determines whether to transmit a reroute non-access stratum (NAS) message.

In some embodiments, the receiver 312 receives a request message. In various embodiments, the processor 302 determines whether to obtain security context information from a fourth network device. In certain embodiments, the transmitter 310, in response to determining to obtain the security context information, transmits a request for the security context information to the fourth network device.

In certain embodiments, during a mobility registration update procedure, an indirect access and mobility management function (“AMF”) reallocation and reroute via a radio access network (“RAN”) enables a non-access stratum (“NAS”) security to be established between a user equipment (“UE”) and an initial AMF that is not capable of serving a UE and may lead to a registration failure.

In some embodiments, during a mobility registration update, an initial AMF that receives a registration request with fifth generation (“5G”) globally unique temporary UE identifier (“GUTI”) (“5G-GUTI”), if it has an N14 interface with the old AMF, it may fetch a subscription permanent identifier (“SUPI”) and a current UE security context or a new Kamf from an old AMF. In various embodiments, there may be key handling in a mobility registration update procedure in which an initiated NAS security mode command procedure with a UE is used to setup the NAS security with the UE based on a security context fetched from an old AMF. The old AMF may be referred to as a source AMF and an initial AMF may be referred to as a target AMF. In certain embodiments, as an initial AMF, after fetching SUPI from an old AMF, it does not fetch subscription information from a unified data management (“UDM”) to determine whether it is capable of serving the UE. This may lead to a case where it may not be able to serve the UE, but according to a security context fetched from the old AMF, it may setup NAS security with the UE. If the initial AMF finds that it is not capable of serving the UE, even if it reroutes the initial NAS message to the new target AMF, the target AMF may not be able to send unprotected NAS messages to the UE because the UE may not process any unprotected NAS message once it has set up a secure NAS connection.

In various embodiments, if an AMF receives a registration request, the AMF may need to reroute the registration request to another AMF (e.g., if the initial AMF is not the appropriate AMF to serve the UE). Registration by an AMF re-allocation procedure may be used to reroute an NAS message of the UE to the target AMF during a registration procedure.

In certain embodiments, if a UE can fetch SUPI from an old AMF, in addition running a NAS security mode command (“SMC”) between the UE and an initial AMF to set up NAS security before determining if an initial AMF is capable to serve the UE (e.g., before determining if a AMF reallocation and reroute via RAN is required) is actually violating determination steps related to AMF reallocation, which says the primary authentication or a NAS SMC can be run only if the AMF needs SUPI and/or subscription information.

In certain embodiments, if an AMF needs a SUPI and/or a UE's subscription information to decide whether to reroute a registration request or if the registration request was not sent integrity protected or integrity protection is indicated as failed, then the AMF may perform various steps.

In some embodiments, if an initial AMF, based on local policy and subscription information, decides to forward an NAS message to a target AMF via a RAN unless the target AMFs are returned from a network slice selection function (“NSSF”) and identified by a list of candidate AMFs. The initial AMF may send a reroute NAS message to the RAN. The reroute NAS message includes the information about the target AMF, and the full registration request message. If the initial AMF has obtained certain information, that information may be included. In various embodiments, a RAN sends an initial UE message to a target AMF indicating a reroute due to slicing including with certain information provided by an NSSF.

In certain embodiments, registration failure may be inhibited by enforcing an initial AMF receiving a registration request with 5G-GUTI (e.g., during a mobility registration update) from a UE, which may fetch the SUPI and related UE security context from an old AMF to perform an AMF serving capability check before establishing any NAS SMC with the UE.

In a first embodiment, there may be handling of a mobility registration update procedure to allow a UE to establish NAS security with a reallocated AMF.

In some embodiments, an AMF that receives a UE registration request (or initial NAS message) with 5G-GUTI may be referred to as an initial AMF. The reallocated AMF may be referred to as a target AMF. The AMF which corresponds to the 5G-GUTI and which may have a previously established UE context may be referred to as an old AMF.

In various embodiments, there may be initial and old AMFs having an N14 interface.

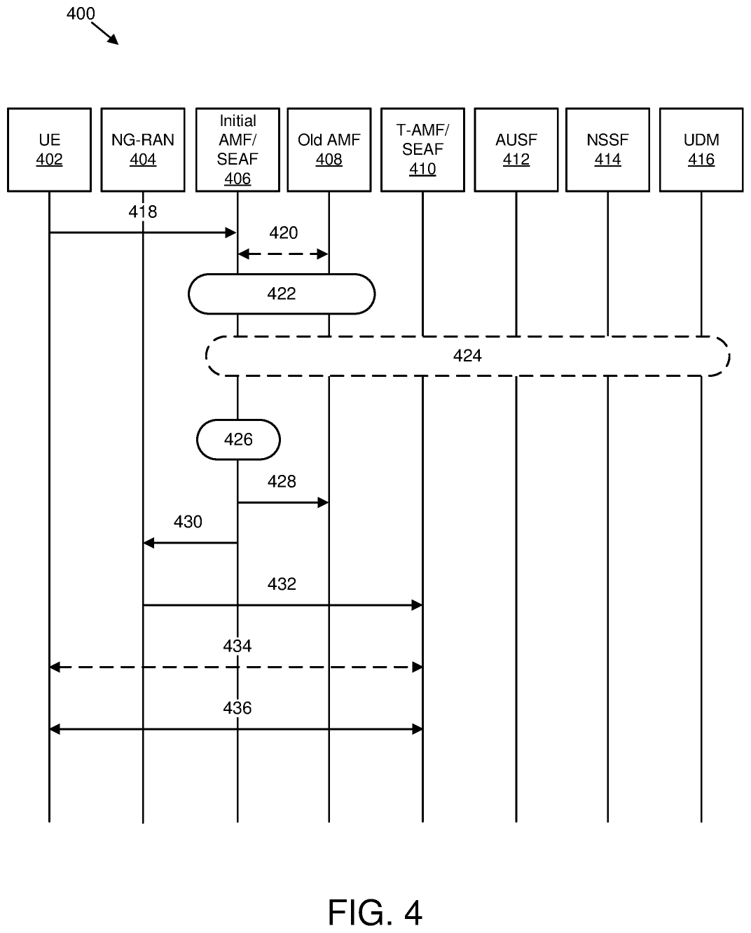

In some embodiments, AMF reallocation and rerouting (e.g., via RAN), where the initial and old AMF has N14 interface, is shown in FIG. 4. The reallocated target AMF does not have any N14 interface with the initial AMF and old AMF due to slice isolation.

FIG. 4 is a schematic block diagram illustrating one embodiment of a system 400 for determining, at an initial AMF, to not use a UE context fetched from an old AMF and/or to skip NAS SMC. The system 400 includes a UE 402, a next generation (“NG”) RAN (“NG-RAN”) 404, an initial AMF and/or SEAF (“AMF/SEAF”) 406, an old AMF 408, a target (“T”) AMF and/or SEAF (“T-AMF/SEAF”) 410, an AUSF 412, an NSSF 414, and a UDM 416. Each of the communications described may include one or more messages.

In a first communication 418, the UE 402 sends a registration request with 5G-GUTI to the initial AMF/SEAF 406.

In a second communication 420, the initial AMF/SEAF 406 upon receiving the registration request with the 5G-GUTI, sends a message to the old AMF 408 which contains 5G-GUTI and the received registration request. One of at least three cases may occur. As SUPI and subscription information may be critical information required for the initial AMF/SEAF 406 to determine a requirement of AMF reallocation and rerouting, a new behavior for the initial AMF/SEAF 406 for various cases to delay primary authentication and/or NAS security set up with the initial AMF/SEAF 406 based on the SUPI fetched from the old AMF 408 and subscription information (e.g., which can be fetched from the UDM 416 by using the available SUPI during step 426).

Three cases are illustrated in relation to a third communication 422, a fourth communication 424, step 426, and/or a fifth communication 428.

For case 1: the initial AMF/SEAF 406 receives SUPI and a current 5G security context. The initial AMF/SEAF 406 may determine to check an AMF serving capability using SUPI and fetch subscription information from the UDM 416. If an indirect AMF allocation is required, the initial AMF/SEAF 406 does not send any NAS message to the UE 402, and in turn performs rerouting via the NG-RAN 404. In step 426, upon receiving SUPI and the current 5G security context, the initial AMF/SEAF 406 performs the following: 1) determines not to respond to the UE 402 until the initial AMF/SEAF 406 determines if a reroute is required or not based on the SUPI and subscription information; and 2) determines not to initiate a NAS SMC with the UE 402 (e.g., corresponding to the fetched 5G security context) until a reroute determination is performed. The subscription information required for the reroute determination may be fetched by the initial AMF/SEAF 406 from the UDM 416 using the SUPI. After fetching the subscription information, if a reroute is required, then the initial AMF/SEAF 406 may perform network slice selection (e.g., using an NSSF 414 service operation) and may discover the T-AMF/SEAF 410 if the initial AMF/SEAF 406 based on local policy and subscription determines that a reroute via the NG-RAN 404 is required. If the initial AMF/SEAF 406 determines to perform a reroute via the NG-RAN 404, then the initial AMF/SEAF 406 performs the following: 1) determining not to use the fetched 5G security context; and/or 2) determining not to initiate a NAS SMC with the UE 402. In step 426, if another AMF is selected, the initial AMF/SEAF 406 sends a reject indication to the old AMF 408 telling that the UE 402 registration procedure did not fully complete at the initial AMF/SEAF 406. The old AMF 408 continues as if the Namf_Communication_UEContextTransfer had never been received.

For case 2: the initial AMF/SEAF 406 receives SUPI, KeyAmfHDerivationInd, and a new Kamf (e.g., if the old AMF 408 after providing deletes the context). The initial AMF/SEAF 406 may determine to check an AMF serving capability using SUPI and may fetch subscription information from the UDM 416 if an indirect AMF/SEAF 406 reallocation is required, and the indirect AMF/SEAF 406 may determine not to use the Kamf received from the old AMF 408. In step 426, if the initial AMF/SEAF 406 fetches SUPI, KeyAmfHDerivationInd, and the new Kamf, the initial AMF/SEAF 406 performs the following: 1) determining not to use the received new Kamf until the initial AMF/SEAF 406 determines if a reroute is required or not based on the SUPI and subscription information; and/or 2) determining not to initiate a NAS SMC with the UE 402 (e.g., corresponding to the fetched new Kamf) until a reroute determination is performed. The subscription information required for the reroute determination may be fetched by the initial AMF/SEAF 406 from the UDM 416 using the SUPI. After fetching the subscription information, if a reroute is required, then the initial AMF/SEAF 406 may perform network slice selection (e.g., using NSSF 414 service operation) and may discover the T-AMF/SEAF 410 if the initial AMF/SEAF 406 based on local policy and subscription determines that a reroute via the NG-RAN 404 is required. If the initial AMF/SEAF 406 determines to perform a reroute via the NG-RAN 404, then the initial AMF/SEAF 406 performs the following: 1) determining not to use the new Kamf and it may be deleted and/or ignored; and/or 2) determining not to initiate a NAS SMC with the UE 402. In step 426, if another AMF is selected, the initial AMF/SEAF 406 sends a reject indication to the old AMF 408 telling that the UE 402 registration procedure did not fully complete at the initial AMF/SEAF 406. The old AMF 408 continues as if the Namf_Communication_UEContextTransfer had never been received. But there is a chance that the old AMF 408 would have deleted the context after providing it to the initial AMF/SEAF 406.

For case 3: if the UE 402 cannot be identified and/or an integrity check fails at the old AMF 408, then the UE 402 may indicate that 5G-GUTI cannot be retrieved. The initial AMF/SEAF 406 performs an identity request and/or response procedure to get the subscription concealed identifier (“SUCI”) of the UE 402 and then a primary authentication is initiated with the UE 402.

In a sixth communication 430 and/or a seventh communication 432, for case 1 and case 2 above, if an AMF reallocation and reroute via NG-RAN 404 is determined by the initial AMF/SEAF 406, then a full registration request and/or initial NAS message may be rerouted to the T-AMF/SEAF 410 via the NG-RAN 404.

In an eighth communication 434, the T-AMF/SEAF 410, upon receiving the initial NAS message with 5G-GUTI, finds that it is not able to identify the related old AMF 408 and considers that it cannot identify the UE 402 with 5G-GUTI and initiated an identity request procedure with the UE 402 and get SUCI.

In a ninth communication 436, based on received SUCI, primary authentication may be initiated. If the primary authentication is successful, then the T-AMF/SEAF 410 may determine if it is capable to serve the UE 402 before sending the NAS SMC and, if it finds that it is capable to serve the UE 402, then the T-AMF/SEAF 410 may establish NAS security with the UE 402.

In certain embodiments, for case 1 and 2, if the initial AMF/SEAF 406 may fetch a security context from the old AMF 408, the initial AMF/SEAF 406 determines to initiate a NAS SMC with the UE 402 in response to: determining the initial AMF/SEAF 406 as capable to serve the UE 402, determining not to perform AMF reallocation with reroute via the NG-RAN 404, determining not to perform AMF reallocation, determining no AMF reallocation is required, and/or determining based on local policy that it can serve all slices returned by the NSSF 414 for the UE 402 based on UE 402 slice selection subscription data.

In some embodiments, for case 1 and 2, the initial AMF/SEAF 406 may fetch a security context from the old AMF 408, the initial AMF/SEAF 406 determines to use the fetched 5G security context and/or initiate a NAS SMC with UE in response to: determining the initial AMF/SEAF 406 as capable to serve the UE 402, determining not to perform AMF reallocation with reroute via the NG-RAN 404, determining not to perform AMF reallocation, determining no AMF reallocation is required, and/or determining based on local policy that it can serve all slices returned by the NSSF 414 for the UE 402 based on UE 402 slice selection subscription data.

In various embodiments, for case 1 and 2, the initial AMF/SEAF 406 determines to use the fetched Kamf, KeyAmfHDerivationInd and/or initiate a NAS SMC with the UE 402 in response to: determining the initial AMF/SEAF 406 as capable to serve the UE 402, determining not to perform AMF reallocation with reroute via the NG-RAN 404, determining not to perform AMF reallocation, determining no AMF reallocation is required, and/or determining based on local policy that it can serve all slices returned by the NSSF 414 for the UE 402 based on UE 402 slice selection subscription data.

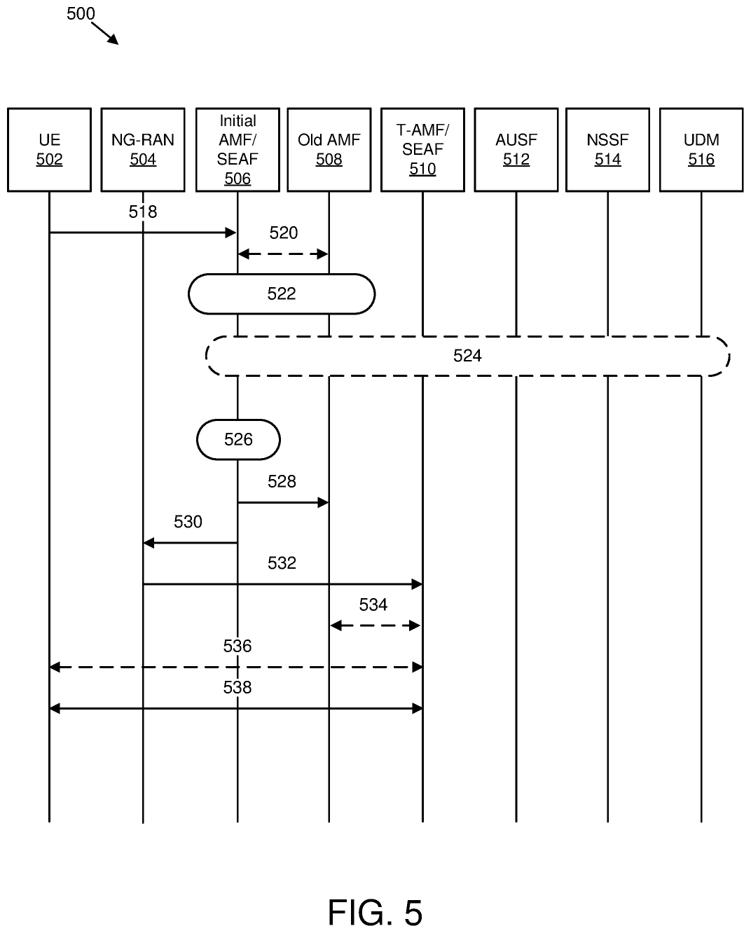

In certain embodiments, an initial AMF/SEAF and old AMF may have an N14 interface and also a target AMF and old AMF have an N14 interface. The AMF reallocation and reroute (e.g., via RAN) where the initial and old AMF has the N14 interface and also the target AMF and old AMF have N14 interface is shown in FIG. 5. The reallocated target AMF does not have any N14 interface with the initial AMF due to slice isolation.

FIG. 5 is a schematic block diagram illustrating another embodiment of a system 500 for determining, at an initial AMF, to not use a UE context fetched from an old AMF and/or to skip NAS SMC. The system 500 includes a UE 502, a NG-RAN 504, an initial AMF/SEAF 506, an old AMF 508, a T-AMF/SEAF 510, an AUSF 512, an NSSF 514, and a UDM 516. Each of the communications described may include one or more messages.

In a first communication 518, the UE 502 sends a registration request with 5G-GUTI to the initial AMF/SEAF 506.

In a second communication 520, the initial AMF/SEAF 506 upon receiving the registration request with the 5G-GUTI, sends a message to the old AMF 508 which contains 5G-GUTI and the received registration request. One of at least three cases may occur. As SUPI and subscription information may be critical information required for the initial AMF/SEAF 506 to determine a requirement of AMF reallocation and rerouting, a new behavior for the initial AMF/SEAF 506 for various cases to delay primary authentication and/or NAS security set up with the initial AMF/SEAF 506 based on the SUPI fetched from the old AMF 508 and subscription information (e.g., which can be fetched from the UDM 516 by using the available SUPI during step 526).

Three cases are illustrated in relation to a third communication 522, a fourth communication 524, step 526, and/or a fifth communication 528.

For case 1: the initial AMF/SEAF 506 receives SUPI and a current 5G security context. The initial AMF/SEAF 506 may determine to check an AMF serving capability using SUPI and fetch subscription information from the UDM 516. If an indirect AMF allocation is required, the initial AMF/SEAF 506 does not send any NAS message to the UE 502, and in turn performs rerouting via the NG-RAN 504. In step 526, upon receiving SUPI and the current 5G security context, the initial AMF/SEAF 506 performs the following: 1) determines not to respond to the UE 502 until the initial AMF/SEAF 506 determines if a reroute is required or not based on the SUPI and subscription information; and 2) determines not to initiate a NAS SMC with the UE 502 (e.g., corresponding to the fetched 5G security context) until a reroute determination is performed. The subscription information required for the reroute determination may be fetched by the initial AMF/SEAF 506 from the UDM 516 using the SUPI. After fetching the subscription information, if a reroute is required, then the initial AMF/SEAF 506 may perform network slice selection (e.g., using an NSSF 514 service operation) and may discover the T-AMF/SEAF 510 if the initial AMF/SEAF 506 based on local policy and subscription determines that a reroute via the NG-RAN 504 is required. If the initial AMF/SEAF 506 determines to perform a reroute via the NG-RAN 504, then the initial AMF/SEAF 506 performs the following: 1) determining not to use the fetched 5G security context; and/or 2) determining not to initiate a NAS SMC with the UE 502. In step 526, if another AMF is selected, the initial AMF/SEAF 506 sends a reject indication to the old AMF 508 telling that the UE 502 registration procedure did not fully complete at the initial AMF/SEAF 506. The old AMF 508 continues as if the Namf_Communication_UEContextTransfer had never been received.

For case 2: the initial AMF/SEAF 506 receives SUPI, KeyAmfHDerivationInd, and a new Kamf (e.g., if the old AMF 508 after providing deletes the context). The initial AMF/SEAF 506 may determine to check an AMF serving capability using SUPI and may fetch subscription information from the UDM 516 if an indirect AMF/SEAF 506 reallocation is required, and the indirect AMF/SEAF 506 may determine not to use the Kamf received from the old AMF 508. In step 526, if the initial AMF/SEAF 506 fetches SUPI, KeyAmfHDerivationInd, and the new Kamf, the initial AMF/SEAF 506 performs the following: 1) determining not to use the received new Kamf until the initial AMF/SEAF 506 determines if a reroute is required or not based on the SUPI and subscription information; and/or 2) determining not to initiate a NAS SMC with the UE 502 (e.g., corresponding to the fetched new Kamf) until a reroute determination is performed. The subscription information required for the reroute determination may be fetched by the initial AMF/SEAF 506 from the UDM 516 using the SUPI. After fetching the subscription information, if a reroute is required, then the initial AMF/SEAF 506 may perform network slice selection (e.g., using NSSF 514 service operation) and may discover the T-AMF/SEAF 510 if the initial AMF/SEAF 506 based on local policy and subscription determines that a reroute via the NG-RAN 504 is required. If the initial AMF/SEAF 506 determines to perform a reroute via the NG-RAN 504, then the initial AMF/SEAF 506 performs the following: 1) determining not to use the new Kamf and it may be deleted and/or ignored; and/or 2) determining not to initiate a NAS SMC with the UE 502. In step 526, if another AMF is selected, the initial AMF/SEAF 506 sends a reject indication to the old AMF 508 telling that the UE 502 registration procedure did not fully complete at the initial AMF/SEAF 506. The old AMF 508 continues as if the Namf_Communication_UEContextTransfer had never been received. But there is a chance that the old AMF 508 would have deleted the context after providing it to the initial AMF/SEAF 506.

For case 3: if the UE 502 cannot be identified and/or an integrity check fails at the old AMF 508, then the UE 502 may indicate that 5G-GUTI cannot be retrieved. The initial AMF/SEAF 506 performs an identity request and/or response procedure to get the SUCI of the UE 502 and then a primary authentication is initiated with the UE 502.

In a sixth communication 530 and/or a seventh communication 532, for case 1 and case 2 above, if an AMF reallocation and reroute via NG-RAN 504 is determined by the initial AMF/SEAF 506, then a full registration request and/or initial NAS message may be rerouted to the T-AMF/SEAF 510 via the NG-RAN 504.

In a seventh communication 534, the T-AMF/SEAF 510, upon receiving the initial NAS message with 5G-GUTI, finds it can contact the corresponding old AMF 508. The T-AMF/SEAF 510 performs the following: 1) case 1: based on local policy and rerouting due to a slicing indication received in a reroute NAS message, the T-AMF/SEAF 510 determines to perform an identity request and/or response procedure and primary authentication; and/or 2) case 2: based on local policy and rerouting due to a slicing indication received in a reroute NAS message, the T-AMF/SEAF 510 determines not to fetch the security context from the old AMF 508.

In various embodiments, the T-AMF/SEAF 510 may send 5G-GUTI and registration request to the old AMF 508 and performs: 1) case 1: receiving SUPI and a current 5G security context—then initiate NAS SMC with the UE 502 based on the received security context; 2) case 2: receiving SUPI, KeyAmfHDerivationInd, and a new Kamf (e.g., where the old AMF 508 after providing deletes the context)—then NAS SMC is initiated with the UE 502 based on the received new Kamf—if no security context and/or Kamf is received and/or if the 5G-GUTI cannot be identified as the old AMF have deleted it, then the process may be similar to case 3; and/or 3) case 3: if the UE 502 cannot be identified and/or the integrity check fails at the old AMF 508, then indicate 5G-GUTI cannot be retrieved—and then the T-AMF/SEAF 510 performs an identity request and/or response with the UE 502.

In an eighth communication 536 and/or a ninth communication 538, based on the received SUCI the T-AMF/SEAF 510 may initiate primary authentication. If the primary authentication is successful, then the T-AMF/SEAF 510 may check it is capable to serve the UE 502 before sending the NAS SMC and if the T-AMF/SEAF 510 finds that it is capable to serve the UE 502, then the T-AMF/SEAF 510 establishes NAS security with UE 502.

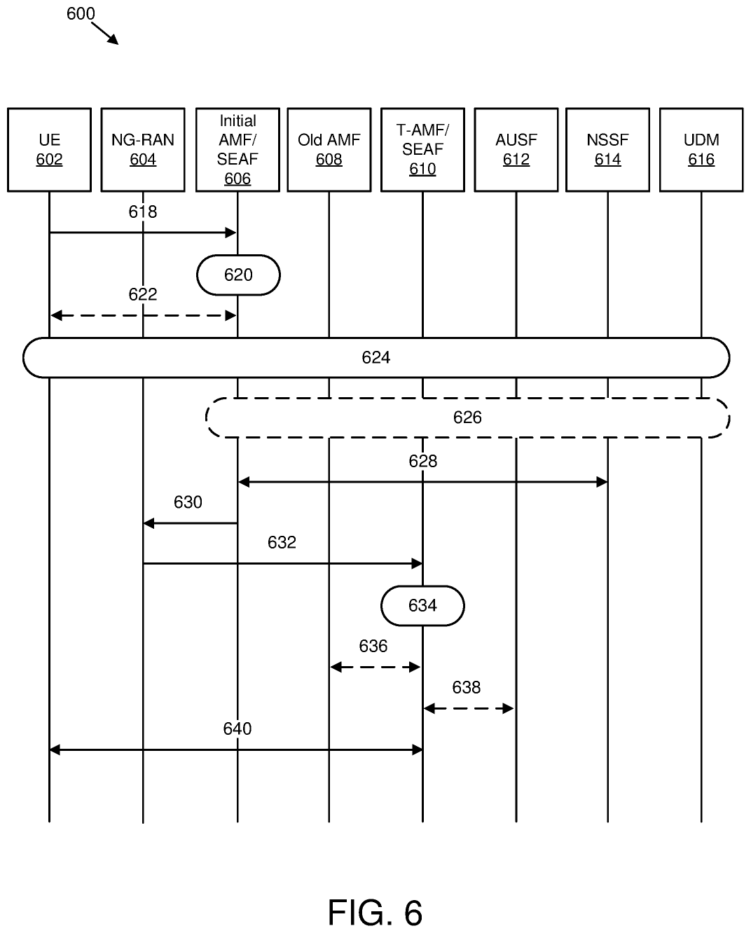

In certain embodiments, there may be a target AMF and an old AMF having an N14 interface. The AMF reallocation and rerouting (e.g., via a RAN) where the initial and old AMF has no N14 interface and a target AMF and old AMF have an N14 interface is shown in FIG. 6. The reallocated target AMF does not have any N14 interface with the initial AMF due to slice isolation.

FIG. 6 is a schematic block diagram illustrating one embodiment of a system 600 for determining, at a target AMF, to fetch an available UE security context from an old AMF or from an AUSF. The system 600 includes a UE 602, a NG-RAN 604, an initial AMF/SEAF 606, an old AMF 608, a T-AMF/SEAF 610, an AUSF 612, an NSSF 614, and a UDM 616. Each of the communications described may include one or more messages.

In a first communication 618, the UE 602 sends a registration request with 5G-GUTI to the initial AMF/SEAF 606.

The initial AMF/SEAF 606, upon receiving 5G-GUTI, finds 620 that the UE 602 cannot be identified with 5G-GUTI.

In a second communication 622, the initial AMF/SEAF 606 initiates an identity request procedure with the UE 602.

In a third communication 624, primary authentication is performed with the UE 602.

In a fourth communication 626, during primary authentication, if an authentication verification at the network is successful, the initial AMF/SEAF 606 determines to perform a service capability check using the SUPI provided by the AUSF 612 and based on the subscription information fetched from the UDM 616.

In a fifth communication 628, if the AMF finds that it is not capable to serve the UE 602 and that AMF reallocation with reroute via RAN is required, then the initial AMF/SEAF 606 determines not to perform NAS SMC with the UE 602 and facilitates reallocation security availability at the AUSF 612 for the new T-AMF/SEAF 610 selected and receives an authentication information (e.g., AMF_AUTN and/or NAS_SecID) from the AUSF 612.

In a sixth communication 630 and/or a seventh communication 632, the initial AMF/SEAF 606 reroutes the initial NAS message via TAN to the T-AMF/SEAF 610 which contains authentication information and rerouting due to a slicing indication.

The T-AMF/SEAF 610, upon receiving the reroute NAS message (e.g., registration request with 5G-GUTI) and based on local policy, receives 634 authentication information and reroutes due to slicing indication, and determines to fetch a security context related to authentication information received in the reroute NAS message from the AUSF 612.

In some embodiments, based on local policy, authentication information, and/or rerouting due to the slicing indication, the T-AMF/SEAF 610 determines not to fetch a security context from the old AMF 608.

In an eighth communication 636 and/or a ninth communication 638, based on the determinations of the T-AMF/SEAF 610, the security context may be fetched from either the AUSF 612 and/or the T-AMF/SEAF 610.

In a tenth communication 640, an NAS security mode command procedure is run with the UE 602 to setup NAS security.

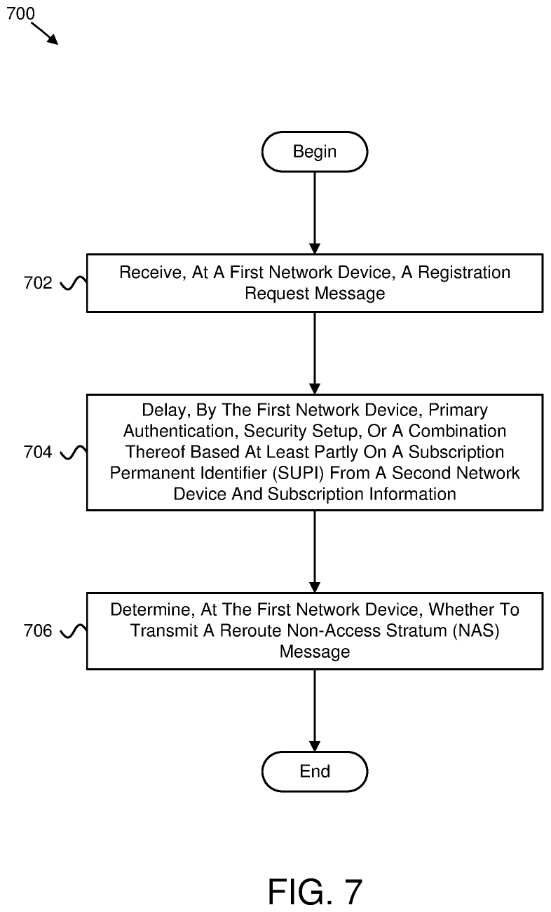

FIG. 7 is a flow chart diagram illustrating one embodiment of a method 700 for rerouting message transmissions. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a first network device, a registration request message. In some embodiments, the method 700 includes delaying 704, by the first network device, primary authentication, security setup, or a combination thereof based at least partly on a subscription permanent identifier (SUPI) from a second network device and subscription information (e.g., slice selection subscription information). In certain embodiments, the method 700 includes determining 706, at the first network device, whether to transmit a reroute non-access stratum (NAS) message.

In certain embodiments, the first network device comprises an initial access and mobility management function (AMF), an initial security anchor function (SEAF)), or a combination thereof. In some embodiments, the second network device comprises an old AMF, an old SEAF, or a combination thereof. In various embodiments, delaying the primary authentication, the security setup, or the combination thereof comprises checking an AMF serving capability using the SUPI and the subscription information (e.g., slice selection subscription information).

In one embodiment, determining whether to transmit the reroute NAS message comprises determining to transmit the reroute NAS message in response to an indirect AMF allocation being used. In certain embodiments, in response to determining to transmit the reroute NAS message, a NAS message is not transmitted to a user equipment (UE), a security context is not used, a NAS security mode command (SMC) is not initiated with the UE, or some combination thereof. In some embodiments, in response to determining to transmit the reroute NAS message: a Kamf from the second network device is not used, the Kamf is deleted, the Kamf is ignored, an NAS SMC is not initiated with the UE, or some combination thereof.

In various embodiments, the method 700 further comprises determining not to transmit the reroute NAS message in response to determining that the first network device is capable of serving a UE, determining not to perform AMF reallocation with reroute, determining not to perform AMF reallocation, determining that AMF reallocation is not required, determining that the first network device can serve all slices returned by a network slice selection function (NSSF) for the UE based on UE slice selection subscription data, or some combination thereof. In one embodiment, the method 700 further comprises determining to use a security context, initiate an NAS SMC with the UE, or a combination thereof.

In certain embodiments, the method 700 further comprises determining to use a Kamf, initiate an NAS SMC with the UE, or a combination thereof. In some embodiments, the method 700 further comprises determining to initiate NAS SMC with the UE or determining to use the fetched security context in response to determining that the first network device is capable of serving a UE, determining not to perform AMF reallocation with reroute, determining not to perform AMF reallocation, determining that AMF reallocation is not required, determining that the first network device can serve all slices returned by a NSSF for the UE based on UE slice selection subscription data, or some combination thereof. In various embodiments, delaying primary authentication, security setup, or the combination thereof comprises skipping primary authentication.

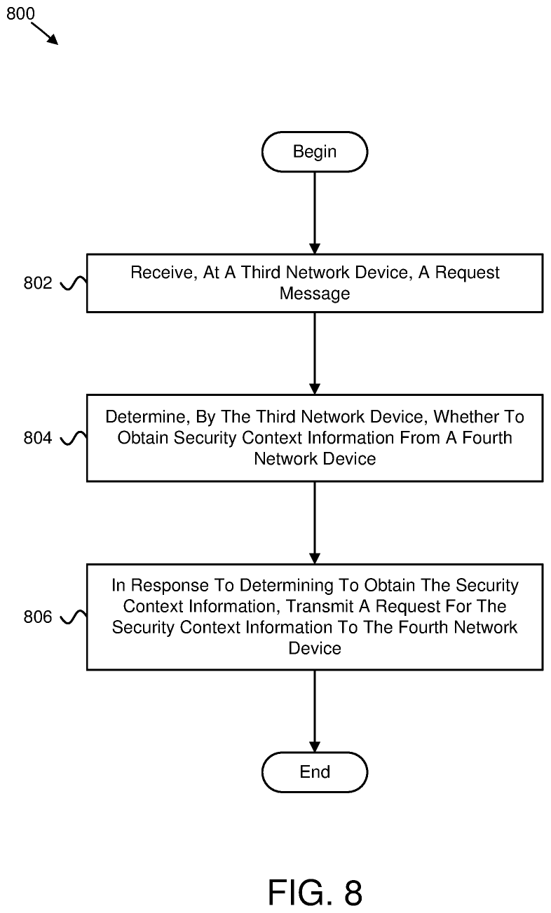

FIG. 8 is a flow chart diagram illustrating another embodiment of a method 800 for rerouting message transmissions. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a third network device, a request message. In some embodiments, the method 800 includes determining 804, by the third network device, whether to obtain security context information from a fourth network device. In certain embodiments, the method 800 includes, in response to determining to obtain the security context information, transmitting 806 a request for the security context information to the fourth network device.

In certain embodiments, determining whether to obtain the security context information from the fourth network device comprises determining whether to obtain the security context information from the fourth network device based on a local policy, received authentication information, received reroute information due to slicing, or some combination thereof. In some embodiments, the third network device comprises a target access and mobility management function (AMF), a target security anchor function (SEAF)), or a combination thereof.

In various embodiments, the request message comprises a reroute non-access stratum (NAS) message or a registration request message. In one embodiment, the fourth network device comprises an authentication server function (AUSF) or an old AMF.

In one embodiment, an apparatus comprises a first network device. The apparatus further comprises: a receiver that receives a registration request message; and a processor that: delays primary authentication, security setup, or a combination thereof based at least partly on a subscription permanent identifier (SUPI) from a second network device and subscription information (e.g., slice selection subscription information); and determines whether to transmit a reroute non-access stratum (NAS) message.

In certain embodiments, the first network device comprises an initial access and mobility management function (AMF), an initial security anchor function (SEAF)), or a combination thereof.

In some embodiments, the second network device comprises an old AMF, an old SEAF, or a combination thereof.

In various embodiments, the processor delaying the primary authentication, the security setup, or the combination thereof comprises the processor checking an AMF serving capability using the SUPI and the subscription information (e.g., slice selection subscription information).

In one embodiment, the processor determining whether to transmit the reroute NAS message comprises the processor determining to transmit the reroute NAS message in response to an indirect AMF allocation being used.

In certain embodiments, in response to the processor determining to transmit the reroute NAS message, a NAS message is not transmitted to a user equipment (UE), a security context is not used, a NAS security mode command (SMC) is not initiated with the UE, or some combination thereof.

In some embodiments, in response to the processor determining to transmit the reroute NAS message: a Kamf from the second network device is not used, the Kamf is deleted, the Kamf is ignored, an NAS SMC is not initiated with the UE, or some combination thereof.

In various embodiments, the processor determines not to transmit the reroute NAS message in response to the processor determining that the first network device is capable of serving a UE, determining determines not to perform AMF reallocation with reroute, determining not to perform AMF reallocation, determining that AMF reallocation is not required, determining that the first network device can serve all slices returned by a network slice selection function (NSSF) for the UE based on UE slice selection subscription data, or some combination thereof.

In one embodiment, the processor determines to use a security context, initiate an NAS SMC with the UE, or a combination thereof.

In certain embodiments, the processor determines to use a Kamf, initiate an NAS SMC with the UE, or a combination thereof.

In some embodiments, the processor determines to initiate NAS SMC with the UE or determines to use the fetched security context in response to the processor determining that the first network device is capable of serving a UE, determining not to perform AMF reallocation with reroute, determining not to perform AMF reallocation, determining that AMF reallocation is not required, determining that the first network device can serve all slices returned by a NSSF for the UE based on UE slice selection subscription data, or some combination thereof.

In various embodiments, the processor delaying primary authentication, security setup, or the combination thereof comprises the processor skipping primary authentication.

In one embodiment, a method of a first network device comprises: receiving, at the first network device, a registration request message; delaying, by the first network device, primary authentication, security setup, or a combination thereof based at least partly on a subscription permanent identifier (SUPI) from a second network device and subscription information (e.g., slice selection subscription information); and determining, at the first network device, whether to transmit a reroute non-access stratum (NAS) message.

In certain embodiments, the first network device comprises an initial access and mobility management function (AMF), an initial security anchor function (SEAF)), or a combination thereof.

In some embodiments, the second network device comprises an old AMF, an old SEAF, or a combination thereof.

In various embodiments, delaying the primary authentication, the security setup, or the combination thereof comprises checking an AMF serving capability using the SUPI and the subscription information (e.g., slice selection subscription information).

In one embodiment, determining whether to transmit the reroute NAS message comprises determining to transmit the reroute NAS message in response to an indirect AMF allocation being used.

In certain embodiments, in response to determining to transmit the reroute NAS message, a NAS message is not transmitted to a user equipment (UE), a security context is not used, a NAS security mode command (SMC) is not initiated with the UE, or some combination thereof.

In some embodiments, in response to determining to transmit the reroute NAS message: a Kamf from the second network device is not used, the Kamf is deleted, the Kamf is ignored, an NAS SMC is not initiated with the UE, or some combination thereof.

In various embodiments, the method further comprises determining not to transmit the reroute NAS message in response to determining that the first network device is capable of serving a UE, determining not to perform AMF reallocation with reroute, determining not to perform AMF reallocation, determining that AMF reallocation is not required, determining that the first network device can serve all slices returned by a network slice selection function (NSSF) for the UE based on UE slice selection subscription data, or some combination thereof.

In one embodiment, the method further comprises determining to use a security context, initiate an NAS SMC with the UE, or a combination thereof.

In certain embodiments, the method further comprises determining to use a Kamf, initiate an NAS SMC with the UE, or a combination thereof.

In some embodiments, the method further comprises determining to initiate NAS SMC with the UE or determining to use the fetched security context in response to determining that the first network device is capable of serving a UE, determining not to perform AMF reallocation with reroute, determining not to perform AMF reallocation, determining that AMF reallocation is not required, determining that the first network device can serve all slices returned by a NSSF for the UE based on UE slice selection subscription data, or some combination thereof.

In various embodiments, delaying primary authentication, security setup, or the combination thereof comprises skipping primary authentication.

In one embodiment, an apparatus comprises a third network device. The apparatus further comprises: a receiver that receives a request message; a processor that determines whether to obtain security context information from a fourth network device; and a transmitter that, in response to determining to obtain the security context information, transmits a request for the security context information to the fourth network device.

In certain embodiments, the processor determining whether to obtain the security context information from the fourth network device comprises the processor determining whether to obtain the security context information from the fourth network device based on a local policy, received authentication information, received reroute information due to slicing, or some combination thereof.

In some embodiments, the third network device comprises a target access and mobility management function (AMF), a target security anchor function (SEAF)), or a combination thereof.

In various embodiments, the request message comprises a reroute non-access stratum (NAS) message or a registration request message.

In one embodiment, the fourth network device comprises an authentication server function (AUSF) or an old AMF.

In one embodiment, a method of a third network device comprises: receiving, at the third network device, a request message; determining, by the third network device, whether to obtain security context information from a fourth network device; and, in response to determining to obtain the security context information, transmitting a request for the security context information to the fourth network device.

In certain embodiments, determining whether to obtain the security context information from the fourth network device comprises determining whether to obtain the security context information from the fourth network device based on a local policy, received authentication information, received reroute information due to slicing, or some combination thereof.

In some embodiments, the third network device comprises a target access and mobility management function (AMF), a target security anchor function (SEAF)), or a combination thereof.

In various embodiments, the request message comprises a reroute non-access stratum (NAS) message or a registration request message.

In one embodiment, the fourth network device comprises an authentication server function (AUSF) or an old AMF.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
receive a registration request message;
delay primary authentication, security setup, or a combination thereof based at least partly on a subscription permanent identifier (SUFI) from a second network device and subscription information; and
determine whether to transmit a reroute non-access stratum (NAS) message.

2. The apparatus of claim 1, wherein:
the apparatus comprises an initial access and mobility management function (AMF), an initial security anchor function (SEAF), or a combination thereof;
the second network device comprises an old AMF, an old SEAF, or a combination thereof;
or a combination thereof.

3. The apparatus of claim 1, wherein the at least one processor is configured to cause the apparatus to delay the primary authentication, the security setup, or the combination thereof comprises the at least one processor configured to cause the apparatus to check an access and mobility management function (AMF) serving capability using the SUFI and the subscription information.

4. The apparatus of claim 3, wherein the at least one processor is configured to cause the apparatus to determine whether to transmit the reroute NAS message comprises the at least one processor configured to cause the apparatus to determine to transmit the reroute NAS message in response to an indirect AMF allocation being used.

5. The apparatus of claim 4, wherein, in response to the at least one processor being configured to cause the apparatus to determine to transmit the reroute NAS message, a NAS message is not transmitted to a user equipment (UE), a security context is not used, a NAS security mode command (SMC) is not initiated with the UE, or a combination thereof.

6. The apparatus of claim 4, wherein, in response to the at least one processor being configured to cause the apparatus to determine to transmit the reroute NAS message: a Kamf from the second network device is not used, the Kamf is deleted, the Kamf is ignored, an NAS security mode command (SMC) is not initiated with a user equipment (UE), or a combination thereof.

7. The apparatus of claim 1, wherein the at least one processor is configured to cause the apparatus to determine not to transmit the reroute NAS message in response to determining that the apparatus is capable of serving a user equipment (UE), determining not to perform access and mobility management function (AMF) reallocation with reroute, determining not to perform AMF reallocation, determining that AMF reallocation is not required, determining that the apparatus can serve all slices returned by a network slice selection function (NSSF) for the UE based on UE slice selection subscription data, or a combination thereof, wherein:
the at least one processor is configured to cause the apparatus to determine to use a security context, initiate an NAS SMC with the UE, or a combination thereof;
the at least one processor is configured to cause the apparatus to determine to use a Kamf, initiate an NAS SMC with the UE, or a combination thereof;
or a combination thereof.

8. The apparatus of claim 1, wherein the at least one processor is configured to cause the apparatus to determine to initiate NAS security mode command (SMC) with a user equipment (UE) or determine to use a fetched security context in response to the at least one processor being configured to cause the apparatus to determine that the apparatus is capable of serving a UE, determine not to perform access and mobility management function (AMF) reallocation with reroute, determine not to perform AMF reallocation, determine that AMF reallocation is not required, determine that the apparatus can serve all slices returned by a NS SF for the UE based on UE slice selection subscription data, or a combination thereof.

9. The apparatus of claim 1, wherein the at least one processor configured to cause the apparatus to delay primary authentication, security setup, or the combination thereof by the at least one processor being configured to cause the apparatus to skip primary authentication.

10. A method of performing a network function, the method comprising:
receiving, at a first network device, a registration request message;
delaying, by the first network device, primary authentication, security setup, or a combination thereof based at least partly on a subscription permanent identifier (SUFI) from a second network device and subscription information; and
determining, at the first network device, whether to transmit a reroute non-access stratum (NAS) message.

11. An apparatus for performing a network function, the apparatus comprising:
at least one memory; and
at least one processor coupled with the at least one memory and configured to cause the apparatus to:
receive a request message;
determine whether to obtain security context information from a fourth network device; and
in response to determining to obtain the security context information, transmit a request for the security context information to the fourth network device.

12. The apparatus of claim 11, wherein the at least one processor is configured to cause the apparatus to determine whether to obtain the security context information from the fourth network device by the at least one processor being configured to cause the apparatus to determine whether to obtain the security context information from the fourth network device based on a local policy, receive authentication information, receive reroute information due to slicing, or a combination thereof.

13. The apparatus of claim 11, wherein a third network device comprises a target access and mobility management function (AMF), a target security anchor function (SEAF), or a combination thereof.

14. The apparatus of claim 11, wherein the request message comprises a reroute non-access stratum (NAS) message or a registration request message.

15. The apparatus of claim 11, wherein the fourth network device comprises an authentication server function (AUSF) or an old access and mobility management function (AMF).

16. A method of performing a network function, the method comprising:
receiving a request message;
determining whether to obtain security context information from a fourth network device; and
in response to determining to obtain the security context information, transmitting a request for the security context information to a fourth network device.

17. The method of claim 16, wherein determining whether to obtain the security context information from the fourth network device comprises determining whether to obtain the security context information from the fourth network device based on a local policy, received authentication information, received reroute information due to slicing, or a combination thereof.

18. The method of claim 16, wherein a third network device comprises a target access and mobility management function (AMF), a target security anchor function (SEAF), or a combination thereof.

19. The method of claim 16, wherein the request message comprises a reroute non-access stratum (NAS) message or a registration request message.

20. The method of claim 16, wherein the fourth network device comprises an authentication server function (AUSF) or an old access and mobility management function (AMF).
